(19) United States
(12) Patent Application Publication
(10) Pub. No.: US 2010/0237873 A1
(43) Pub. Date: Sep. 23, 2010

(54) CIRCUIT ARRANGEMENT HAVING A BATTERY CASCADE

(76) Inventors: Michael Franke, Darmstadt (DE); Jörn Riemer, Steinbach (DE); Tobias Schädel, Bad Homburg (DE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/741,692

(22) PCT Filed: Sep. 16, 2008
(86) PCT No.: PCT/EP08/07695

§ 371 Date: May 6, 2010

(30) Foreign Application Priority Data
Nov. 7, 2007 (DE) 10 2007 052 929.7

(51) Int. Cl. G01N 27/416; H02J 7/04

(52) U.S. Cl. 324/434; 320/162

(57) ABSTRACT

In an electrical device, in which the load is supplied by a battery cascade, the voltages of the batteries of the battery cascade must be measured with high precision in order to start charge equalization and prevent undervoltages or overvoltages, wherein if possible favorable components should be used simultaneously. This problem is solved in that a circuit arrangement having a battery cascade is proposed, comprising a first battery (A1), the negative pole of which has a ground potential (GND), a second battery (A2), the negative pole of which is coupled to the positive pole of the first battery, and further comprising a capacitor (C1), which on the first side thereof is coupled to the positive pole of the first battery by way of a resistor (R1) and with the second side thereof can be applied to the ground potential (GND) by way of a first switch (S1). Furthermore, the positive pole of the second battery (A2) can be coupled between the resistor (R1) and the capacitor (C2) by way of a second switch (S2). The capacitor (C1) can be charged to the voltage (V1) of the first battery and only the differential voltage between the entire battery cascade and the capacitor (C1) must be measured.

The invention relates to a circuit arrangement having a battery cascade.

Circuit arrangements having a battery cascade are typically used to prevent differences in charge of the individual batteries of the battery cascade and thus prevent premature degradation of a battery.

A circuit arrangement having a battery cascade is described in patent specification DE 39 40 929 C1, in which a control circuit connects series circuit pairs, each attached to the pole connections of a battery of the battery cascade, thus connecting the respective battery with capacitances connected in parallel. Depending on the difference in voltage between the capacitors and the battery connected to them, a charge exchange and charge equalization takes place. Each battery is connected to a comparator circuit that compares the actual voltage with the target voltage on the respective battery and loads the control circuit with the differential voltage. In order to equalize the charge, the circuit pair of a better charged battery is first closed, and the capacitors are charged until they have the voltage of the better charged capacitor. After that, the circuit pair is opened and the circuit pair of a less well charged battery is closed. Then charge flows out of the capacitors into the less well charged battery.

A disadvantage of the described circuit arrangement is that it requires a comparator circuit for each battery for the measurement of the individual battery voltages and an additional circuit with several capacitors for the voltage equalization.

It is the object of the present invention to provide a circuit arrangement and a process in which a precise measurement of the voltages is possible in a battery cascade with a simple circuit arrangement, and voltage equalization is also possible between differently charged batteries.

The problem is solved by a circuit arrangement with the features according to claim 1 and a process with the features according to claim 10. Additional embodiments are given in the dependent claims.

The circuit arrangement according to claim 1 enables the measurement of voltage on the second battery of the battery cascade in that the voltage of the first battery can be stored, and thus the difference between the voltage in the entire battery cascade and the voltage on the capacitor can be measured against a ground potential. This renders it unnecessary for each battery to have an assigned independent measuring circuit, and it also allows the use of a measuring circuit that is not designed for the total voltage in the battery cascade since only the differential voltage, rather than the difference in voltage values at the poles of the second battery, must be measured against a ground potential. Typical voltage values for a battery cascade comprising lithium ion batteries would be about 4.0 volts (V) at the positive pole of the first battery and 8.0 V at the positive pole of the second battery. In the present circuit arrangement, the voltage of the second battery does not have to be measured as a difference of 8.0 V against a ground potential and 4.0 V against a ground potential, but rather the differential voltage of 4.0 V can be measured directly against the ground potential.

In a further embodiment of the circuit arrangement, a measuring circuit is present that can be supplied with the voltage of the first battery directly through a first input, and a second input of the measuring circuit can be supplied with the difference in voltage between the voltage on the capacitor, in its charged state, and the total voltage of the battery cascade. Because of the properties of the circuit arrangement, a measuring circuit, for example a commercially available and economical micro-controller that is designed for a maximum voltage of about 5.5 V, can be used for this purpose.

In another embodiment, the measuring circuit has an analog-digital converter, with which supplied analog voltage values can be converted to digital voltage values, and a memory. Digital voltage values can be saved in the memory in order to be compared to each other, for example, or to make the voltage build-up over time available for later analysis. The analog-digital converter can receive both an analog signal from the first input or from the second input of the measuring circuit; therefore, it is not necessary that two analog-digital converters are provided, and with only one analog-digital converter, each conversion is subject to the same error, so that in calculating the difference between two converted values, the error is essentially deducted. The memory can be designed either as a memory for a digital value or as a memory for several digital values.

In one embodiment, the measuring circuit has yet another comparison unit that is used to compare a previously defined voltage value with a current voltage value.

In a further embodiment, the first circuit and the second circuit can be controlled by the measuring circuit.

In another further embodiment, the positive pole of the second battery can be coupled with the measuring circuit through a third circuit. In this way, the measuring circuit can be supplied with energy through the battery cascade.

In one embodiment, the measuring circuit has an internal reference voltage. This allows the absolute measurement of voltage values, which enables, in particular, the determination of an undervoltage or overvoltage on the respective batteries. Furthermore, a reference voltage also enables a measurement of higher precision.

In a further embodiment, the battery cascade is connected to a charging circuit so that the batteries can be charged via the charging circuit. The charging circuit can be controlled by the measuring circuit so that when an undervoltage occurs, the batteries can be automatically charged.

The described circuit arrangement can be used, in particular, in electrical devices that are supplied by batteries. Such electrical devices are, in particular, mobile telephones, electric toothbrushes, razors or epilators, wirelessly operated household devices such as a hand blender or wirelessly operated tools such as a cordless screwdriver. Therefore, the invention also relates to an electrical device that features such a circuit arrangement.

Furthermore, the invention relates to a process for measuring voltage in a battery cascade. The process consists of the following steps:
Charging of a capacitor that lies on a ground potential comprising a first capacitor of a battery cascade lying on a ground potential, until the voltage on the first battery is also the same as that on the capacitor at a desired precision.
Decoupling of the capacitor from the ground potential, wherein this, in particular, occurs when a resistor with high impedance (for example, several megohms) is connected between the capacitor and the ground potential.
Application of the total voltage of the battery cascade at the capacitor so that the difference between the voltage at the capacitor and the total voltage can be measured against the ground potential.

In further embodiments of this process, the second battery is partially discharged via a resistor, or the charge current is partly supplied to the second battery through a resistor when the batteries are charged. This allows, whenever high voltage is detected on the second battery in comparison to the voltage on the first battery, for the second battery to be partially discharged via the resistor or to be slowly charged via a discharge of charge current, like the first battery, until the voltages have equalized.

In another further embodiment of the process, a measuring circuit is supplied through the first battery only. In this case, if high voltage is detected on the first battery in comparison to the voltage on the second battery, this provides that the first battery is discharged more rapidly than the second battery, because of the supply of the measuring circuit, so that the voltages can be equalized.

The invention is further explained in detail by the discussion of example embodiments and with reference to figures. In this connection,

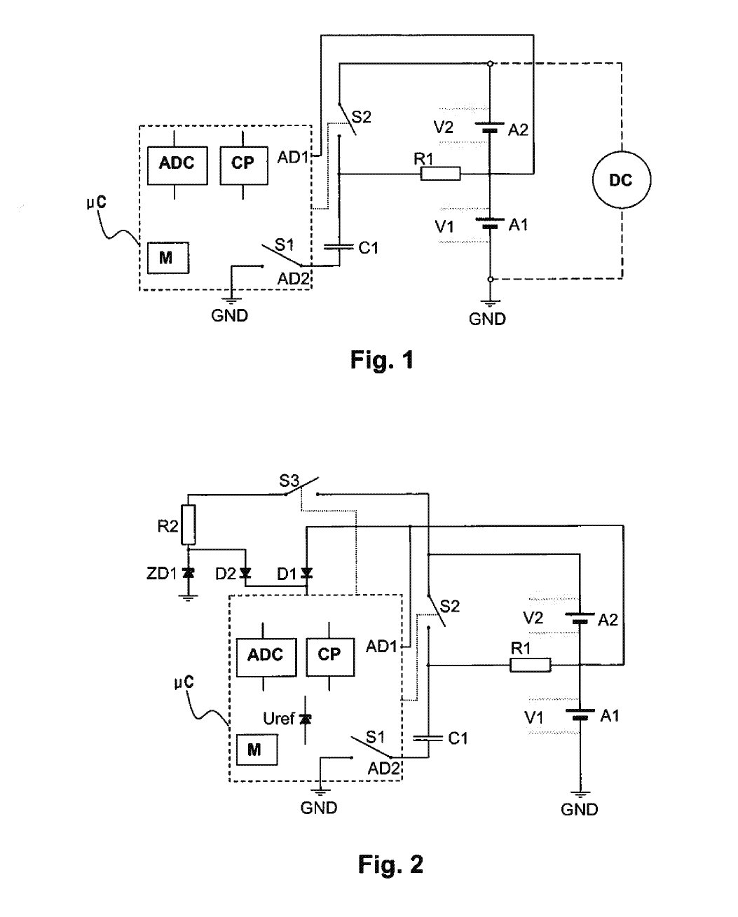

FIG. 1 shows a circuit arrangement for measuring voltages in a battery cascade,

FIG. 2 shows a circuit arrangement which has been expanded by additional components in comparison to FIG. 1, and

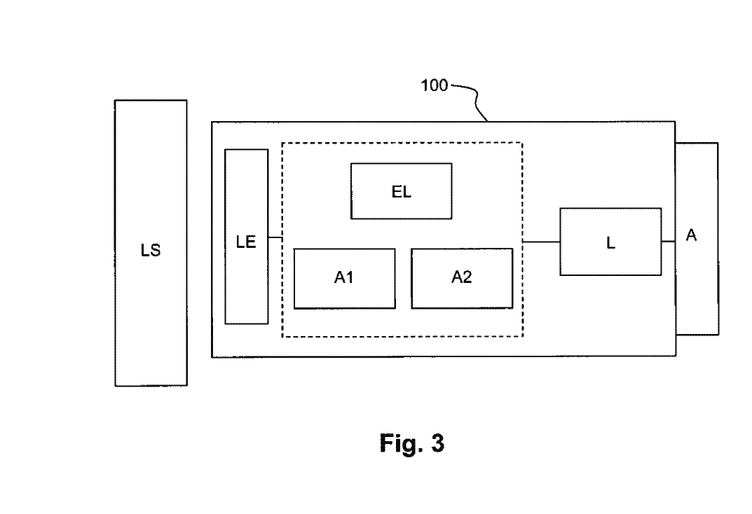

FIG. 3 shows a schematic representation of an electrical device that has a circuit arrangement.

The circuit arrangement according to FIG. 1 has a battery cascade that has a first battery A1 and a second battery A2. The first battery A1 has the voltage V1, and the second battery A2 has the voltage V2. The voltage values are determined by the respective charge status of the batteries. The negative pole of the first battery A1 is connected to a ground potential, for example the earth potential or another ground potential. The positive pole of the first battery A1 is connected both to the negative pole of the second battery A2 and to a resistor R1. The resistor R1 is connected to a capacitor C1, which is connected, in turn, to the ground potential through a first switch S1 in the closed state of the first switch S1. The positive pole of the second battery A2 is coupled in through a second switch S2 between the capacitor C1 and the resistor R1. A measuring circuit μC is indicated by a dashed line. Analogously, voltage values for measuring the first input AD1 and the second input AD2 can be supplied to the measuring circuit μC. The battery cascade can be connected in a well-known manner to a charge circuit DC, with which the battery cascade cannot be discharged through the charge circuit DC, but through which the battery cascade probably can be charged. The measuring circuit μC also serves to control the second switch S2, which is indicated by a dotted line. The first switch S1 is designed here as a component of the measuring circuit μC, and the capacitor is coupled on the ground potential side with the second input AD2 of the measuring circuit. However, the first switch S1 can also be an external switch controlled by the measuring circuit μC. To achieve a high precision of the switch, the second switch S2 can be designed, in particular, as a switch with a low (or practically no) drop in voltage, for example as an FET or MOS-FET.

If the batteries are lithium ion batteries, the voltages V1 and V2 can take on a value of, for example, 2.5-4.2 volts (V) in their operational state, depending on their charge status. A tap at the positive pole of the first battery A1 enables the direct measurement of the voltage V1 on the first battery A1. Such a tap is connected here with the first input AD1 of the measuring circuit μC. The measuring circuit μC can convert the supplied analog voltage value, for example through an analog-digital converter ADC, into a digital voltage value, whereby a 10-bit analog-digital converter enables a precision of about one-thousandth of the reference voltage. The digital voltage value can be saved in a memory M of the measuring circuit μC for further use, for example, for a voltage value comparison (as described below) or to provide the voltage V1 over time.

The illustrated circuit arrangement enables different types of applications that are described in the following. These applications include use

a) as a circuit arrangement for measuring voltages of the battery cascade and

b) as a circuit arrangement for leveling charge states of the first and second batteries.

The function of the circuit arrangement according to FIG. 1 in application a) is as follows. First, the voltage V1 on the first battery A1 is supplied to the measuring circuit μC at the first input AD1 through the tap on the positive pole of the first battery A1. The first input AD1 is fed to an analog-digital converter ACD of the measuring circuit μC, which converts the analog voltage value into a digital voltage value, wherein the analog-digital converter ADC in the described embodiment has a resolution of 10 bits, so that a precision of about 4 mV can be achieved since the maximum voltage to be resolved corresponds to the maximum voltage of the lithium ion battery. In a next step, the first switch S1 is closed and the second switch S2 is opened. Then, the first battery A1 charges the capacitor C1 through the resistor R1. Through appropriate dimensioning of the capacitor C1 (capacitance C) and the resistor R1 (Ohm resistance R), a charge time constant T can be defined as resulting from the product of capacitance C of the capacitor C1 and Ohm resistance R1 of the resistor R1 (T=R×C), the result of which is that the voltage contained on capacitor C1 corresponds, within a charge time of a few milliseconds with a precision of about 0.1% (which corresponds to the dimension at which the analog-digital converter ADC digitalizes the voltage values) to the voltage V1 contained on the first battery A1. A higher or lower precision of the voltage value correspondence can be achieved with a longer or shorter charge time. If the thus desired precision of the voltage on the capacitor C1 is achieved, the first switch S1 is opened, so that a discharge of the capacitor C1 is essentially prohibited (the second input has a very high impedance in the megohm range (Me) when the first switch S1 is open), and only the low leakage currents through the leakage resistance of the capacitor C1 lead to a slow discharge of the capacitor C1. The second switch S2 is then closed so that a voltage value is supplied to the second input AD2 of the measuring circuit μC, which corresponds to the difference between the sum voltage of the voltage V1 on the first battery A1 and the voltage V2 on the second battery A2 and the voltage V1′ on the capacitor C1 (V1′≈V1); therefore, a voltage V=(V1+V2)−V1′=V2′ can be measured against the ground potential.

The voltage V on the second input AD2 therefore corresponds to the voltage V2 with a precision indicated by the precision of the voltage V1′ on the capacitor C1 in reference to the voltage V1 on the first battery A1. By increasing the charge time of the capacitor C1, the precision of this voltage can be increased. Due to the fact that the capacitor C1 is practically not discharged when the first switch S1 is open (which can be guaranteed by selecting a capacitor of suitably good quality) and the voltage measurement can essentially be measured without time delay after closing the second switch S2, a self-discharge of the capacitor C1 is also insignificant for the precision of the voltage measurement. The voltage value on the second input AD2 is fed to an analog-digital converter ADC to convert the analog voltage value to a digital voltage value. The analog-digital converter ADC here is the same to which a voltage value is also fed through the first input AD1; however, the measuring circuit μC could also have several analog-digital converters.

Under the condition that the supply voltage of the measuring circuit μC (which is provided from an external voltage source in the embodiment described in FIG. 1) remains constant, a relative comparison between the stored first digital voltage value, which corresponds to the voltage V1 on the first battery A1, and the second digital voltage value, which corresponds to the voltage V2 on the second battery, can be made, for example using a comparison unit CP of the measuring circuit μC. A difference in the compared voltages indicates that one of the two batteries is more strongly discharged than the other. Corresponding steps for leveling the charge state of the first battery A1 and of the second battery A2 can then be taken.

If the measuring circuit μC provides an internal constant reference voltage Uref (see FIG. 2), the voltage values can also be compared absolutely to each other, and it can be determined, in particular, whether the voltage values approximate a critical low voltage value that corresponds to a nearly complete discharge of the corresponding battery. Necessary steps for preventing a complete discharge can then be introduced (which can be a display of a discharge warning and/or a non-supply of the actual load of the device, accomplished in a known manner). It can also be determined, when the batteries are being charged, whether the respective voltage on the batteries is nearing a critical upper value, and the charging of the batteries can then be stopped. A reference voltage can also be provided externally, of course.

The described circuit arrangement allows the use of a measuring circuit μC, which is not designed for the sum voltage V=V1+V2 of the voltage V1 of the first battery A1 and the voltage V2 of the second battery A2. A microcontroller that is designed for a maximum voltage of about 5.5 V can therefore be used as a measuring circuit, wherein the sum voltage V=V1+V2 is about 8.4 V with fully charged batteries. The circuit arrangement also enables the precise (relative and/or absolute) measurement of the voltages on the batteries in the battery cascade and a precise comparison of the two voltages V1 and V2. Since, during the measurements no currents flow through the capacitor C1, the transfer resistances of the first switch S1 and of the second switch S2 are irrelevant and economical components can be used. Essentially, higher component quality need only be required for the capacitor C1. Thus, for example, a paper or plastic foil capacitor with a high leakage resistance can be used to keep the self-discharge of the capacitor C1, which is used here as a memory for one voltage value, very low.

The function of the circuit arrangement according to FIG. 1 in application b) is as follows. If comparison of the voltages has determined that the voltage V2 on the second battery A2 is greater than the voltage V1 on the first battery, V2>V1, a charge equalization can take place in such a way that the second switch S2 is closed and the second battery is discharged through the resistor R1. Since, in one embodiment, the measuring circuit μC regularly conducts the measurement of the voltage values, the partial discharge of the second battery A2 through the resistor R1 can be stopped by opening the second switch when the voltage V2 on the second battery is the same as the voltage V1 on the first battery A1, V2=V1. If the device is charging, then closing the second switch S2 causes a part of the current to flow through the resistor R1 and not through the second battery A2, so that the first battery A1 is charged more quickly than the second battery A2, therefore equalizing the voltage values V2 on the second battery A2 and V1 on the first battery A1. The measuring circuit μC can also measure the voltage values V1 and V2 and open or close the second switch accordingly during charging of the batteries. If it is determined that the voltage V1 on the first battery A1 is greater than the voltage V2 on the second battery, V1>V2, then the first battery can be used to supply the measuring circuit μC so that the first battery A1 is discharged with currents in the milliampere range (mA) by the supply of the measuring circuit μC, whereas a self-discharge in the resting mode of the battery without supply of a load lies in the microampere range (μA). This is described in the following with reference to FIG. 2.

The same components are basically contained in the circuit arrangement according to FIG. 2 as in FIG. 1, which is why reference is made to the description of FIG. 1 with regard to these components. However, the circuit arrangement according to FIG. 2 is expanded in comparison to the circuit arrangement according to FIG. 1. The positive pole of the first battery is connected to a supply input of the measuring circuit μC through a first diode D1. Furthermore, the positive pole of the second battery A2 is connected to an additional resistor R2 through a third switch S3. The third switch S3 can be controlled by the measuring circuit μC, which is indicated by a dotted line. The additional resistor R2 is connected to the ground potential through a Zener diode, and the additional resistor R2 is connected to the supply input of the measuring circuit μC through a second diode D2. This circuit arrangement allows a third application of the circuit arrangement, namely the supply of the measuring circuit μC by the battery cascade. The measuring circuit μC also has an internal reference voltage Uref that can be used—as already mentioned in connection with FIG. 1—to measure the supplied voltage values absolutely, so that the occurrence of an undervoltage can be recognized and thus the batteries can be protected from the undervoltage, which increases the life expectancy of a battery.

In the embodiment according to FIG. 2, the measuring circuit μC is supplied through the batteries. With the third switch S3 closed, the measuring circuit μC is supplied by both batteries of the battery cascade through the second diode D2. The additional resistor R2 and the Zener diode ZD1 are selected in such a way that even at a sum voltage of both batteries, which lies above the operating voltage of the measuring circuit μC (about 5.5 V), the measuring circuit μC is only supplied with a voltage for which the measuring circuit μC is designed. When supplied by both batteries of the battery cascade, the measuring circuit can then still provide full performance, even when the voltages of the batteries each near the undervoltage limit of about 2.5 V. Furthermore, the measuring circuit μC can also be reliably supplied during a large load applied to the batteries through the loading of the device to be supplied (not shown; with a razor or a household device it deals with the load, typically a motor) since the resulting drops in voltage due to the large load do not lead to an undervoltage of the measuring circuit μC. As already mentioned in connection with FIG. 1, the measuring circuit μC with a voltage V1 of the first battery A1, which is greater than the voltage V2 of the second battery A2, V1>V2, can also be supplied solely by the first battery A1. For this purpose, the third switch S3 is opened. Also in the standby operation of the device, the measuring circuit μC is supplied through the first diode D1, wherein the third switch S3 remains open. In this type of operation, the voltage regulation through the additional resistor R2 and the Zener diode ZD1 is not necessary, and only a few microamperes (μA) are used.

The described circuit arrangement enables a high measuring precision of a few millivolts without the use of cost-intensive components. An economical, commercially available microcontroller can actually be use as a measuring circuit μC.

In FIG. 3, an electrical device 100 that has a circuit arrangement according to the invention is shown. The circuit arrangement consists of the first battery A1, the second battery A2 and the electronic components EL. The batteries supply a load L for the electrical device 100. Such a load can be, for example, a motor, which then drives an application mechanism A. Such an application mechanism A is, for example, a shear blade on an electric razor, a tweezer element in an epilator, a drill head on an electric drill or a cutting edge on a hand-held blender. In a mobile telephone, the load can consist of the display and the transmission and receiving unit. The batteries of the electrical device 100 can be charged at a charging station LS in a known manner by inductive charging or via direct contact. For this purpose, the electrical device 100 contains an electronic charger.

What is claimed is:

1. A circuit arrangement suitable for measuring the respective voltages in the batteries of a battery cascade with
a first battery (A1) whose negative pole is connected to a ground potential (GND),
a second battery (A2) whose negative pole is coupled with the positive pole of the first battery, and
a capacitor (C1) that is coupled on its first side through a resistor (R1) with the positive pole of the first battery (A1) and can be connected on a second side through a first switch (S1) to the ground potential (GND),
wherein the positive pole of the second battery (A2) can be coupled in through a second switch (S2) between the resistor (R1) and the capacitor (C1).

2. The circuit arrangement according to claim 1, which also has a measurement circuit (μC) for evaluating the measured voltages, wherein the positive pole of the first battery (A1) is coupled with a first input (AD1) of the measuring circuit (μC), and the second side of the capacitor (C1) is coupled with a second input (AD2) of the measuring circuit (μC).

3. The circuit arrangement according to claim 2, wherein the measuring circuit (μC) has an analog-digital converter (ADC) for digitalizing supplied analog voltage values and a memory (M) for storing at least one digital voltage value.

4. The circuit arrangement according to claim 2 or claim 3, wherein the measuring circuit (μC) has a comparison unit (CP) for comparing two voltage values.

5. The circuit arrangement according to any of claims 2 through 4, wherein the first switch (S1) and the second switch (S2) are controlled by the measuring circuit (μC).

6. The circuit arrangement according to any of claims 2 through 5, wherein the positive pole of the second battery (A2) can be coupled with the measuring circuit (μC) through a third switch (S3).

7. The circuit arrangement according to any of claims 2 through 6, wherein the measuring circuit (μC) has an internal reference voltage (Uref) for the absolute determination of voltage values.

8. The circuit arrangement according to any of claims 1 through 7, wherein the negative pole of the first battery (A1) and the positive pole of the second battery (A2) are coupled with a charge current (DC) or can be coupled with a charge current (DC).

9. An electrical device (100) with a circuit arrangement according to any of claims 1 through 9, wherein the battery cascade serves to supply a load (L) of the electrical device (100).

10. A process for providing a voltage that is a measure for a voltage in a battery in a battery cascade in which the following steps are carried out:
Charging of a capacitor (C1) connected to a ground potential until the voltage (V1) of a first battery (A1) of the battery cascade connected to the ground potential (GND) approximates that of the capacitor (C1) with a predefined precision,
Decoupling of the capacitor (C1) from the ground potential (GND), in particular by switching a high impedance between the capacitor (C1) and ground potential (GND),
Application of the total voltage from the voltage (V1) of the first battery (A1) and the voltage (V2) of a second battery (A2) of the battery cascade to the capacitor (C1).

11. The process according to claim 10, wherein a partial discharge of the second battery (A2) is conducted through a resistor (R1) as an additional step.

12. The process according to claim 10, wherein a part of the charge current for the second battery (A2) is carried through a resistor (R1) as an additional step in charging the battery cascade.

13. The process according to any of claims 10 through 12, wherein the provision of a measuring circuit (μC), as an additional step, is only carried through the first battery (A1).
